(19) United States
(12) Patent Application Publication
(10) Pub. No.: US 2005/0242219 A1
(43) Pub. Date: Nov. 3, 2005

(54) BATCH-FEED FOOD WASTE DISPOSER HAVING A BAFFLE

(75) Inventor: Steven P. Hanson, Racine, WI (US)

Correspondence Address: LOCKE LIDDELL & SAPP LLP;ATTN. DOCKETING, 600 TRAVIS #3400, HOUSTON, TX, 77002, US

(73) Assignee: EMERSON ELECTRIC CO., St. Louis, MO (US)

(21) Appl. No.: 10/908,134

(22) Filed: Apr. 28, 2005

Related U.S. Application Data
(60) Provisional application No. 60/521,446, filed on Apr. 28, 2004.

(51) Int. Cl. B02C 23/36

(52) U.S. Cl. 241/46.016

(57) ABSTRACT

A food waste disposer system includes an inlet for receiving food waste, a grinding section for grinding the food waste and a stopper receivable by the inlet. The stopper may include a plug for plugging the inlet and an actuator for controlling operation of the disposer. A baffle is situated between the inlet and the grinding section.

### CROSS-REFERENCE TO RELATED APPLICATION

This application is a non-provisional application of U.S. Provisional Patent Application Ser. No. 60/521,446, filed on Apr. 28, 2004, which is incorporated by reference.

### BACKGROUND

The present disclosure relates generally to food waste disposers, and more particularly, to a baffle for batch-feed food waste disposers.

Food waste disposers are used to comminute food scraps into particles small enough to safely pass through household drain plumbing. A conventional disposer includes a food conveying section, a motor section, and a grinding mechanism disposed between the food conveying section and the motor section. The food conveying section includes a housing that forms an inlet connected to a sink flange for receiving food waste and water. The food conveying section conveys the food waste to the grinding mechanism, and the motor section includes a motor imparting rotational movement to a motor shaft to operate the grinding mechanism.

One type of food waste disposer is a “continuous feed” disposer, which is typically actuated by a wall switch. A baffle is situated over the disposer inlet, and food waste can be continuously fed to the disposer through the baffle. The baffle helps keep unwanted items, such as silverware, from inadvertently falling into the disposer.

In comparison, batch-feed waste disposers operate by filling the disposer with waste food, then substantially blocking the drain opening prior to operating the disposer, thereby disposing of food waste in batches. A batch feed disposer uses a stopper device positioned in the drain opening to activate the disposer. The stopper also prevents foreign objects, such as silverware, from entering the disposer during operation, but will typically allow water to flow into the disposer. However, the stopper often is not in place during normal use of the sink, such as for cleaning dishes or cleaning around the sink. When the stopper is not in place, there is nothing to prevent unwanted items such as silverware or food storage containers from falling into the waste disposer.

The present application addresses shortcomings associated with the prior art.

### SUMMARY

Among other things, a batch feed food waste disposer system including a baffle is disclosed herein. The baffle provides a barrier that remains in place when the sink stopper is not in place. The baffle helps prevent unwanted items such as silverware from falling into the waste disposer and becoming damaged or lost. Further, the baffle protects the sink stopper from being hit and damaged by flying particulate during the grinding process. Moreover, the baffle helps make the grinding process quieter by providing another level of barrier the sound must travel through.

In accordance with certain teachings disclosed herein, a food waste disposer includes an inlet for receiving food waste and a grinding section for grinding the food waste. A stopper is receivable by the inlet and a baffle is situated between the inlet and the grinding section. The stopper functions to activate the disposer when received in the inlet. One end of the stopper defines a switch portion for this purpose. The other end defines a plug portion to stop the inlet. In certain exemplary embodiments, the baffle includes an outer lip about the periphery of the baffle and an inner portion defining an opening therethrough. The outer lip is made of material stiffer than the inner portion.

### BRIEF DESCRIPTION OF THE DRAWINGS

Other objects and advantages of the invention will become apparent upon reading the following detailed description and upon reference to the drawings in which:

FIG. 1 is a sectional view illustrating portions of an exemplary batch feed food waste disposer system including baffle in accordance with the present disclosure.

FIG. 2 is a detail view of a portion of the disposer system shown in FIG. 1.

FIG. 3 is a top view of a baffle in accordance with the present disclosure.

FIG. 4 is a side view of an exemplary stopper for a batch feed disposer.

FIG. 5 illustrates portions of a batch feed disposer system employing an alternative baffle configuration.

FIG. 6 illustrates portions of a batch feed disposer system employing another alternative baffle configuration.

FIGS. 7 and 8 illustrates portions of a batch feed disposer system employing yet another alternative baffle configuration.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Known batch feed food waste disposers have lacked a baffle for several reasons. For example, the batch-feed stopper fills up the whole sink-flange area when in place so there is no room for a baffle. Further, the batch-feed switch mechanism takes up a large part of the grind chamber and the sink-flange area leaving little area to put or attach a baffle.

However, the provision of a baffle is desirable for several reasons. As noted above, it can prevent items such as silverware from accidentally falling into the disposer. The present disclosure provides baffle designs and connection methods that keep the stopper/switching mechanism and baffle in different levels or locations in the waste disposer.

It is desirable for such a baffle to provide the maximum opening diameter, while not interfering with the operation of the stopper/switching device. To accomplish this, the proper clearance between the baffle and stopper must be assured. Additionally, the baffle must be mounted securely to prevent it from becoming dislodged and falling into the grind mechanism when food waste is passed through the baffle into the grind mechanism. To achieve this, both hard and soft plastic or rubber are used to construct the baffle, providing a baffle that is flexible and rigid in different areas of the baffle. Thus, the baffle is soft to bend and allow waste to pass through portions of the baffle, while being rigid in other areas to insure a secure placement of the baffle.

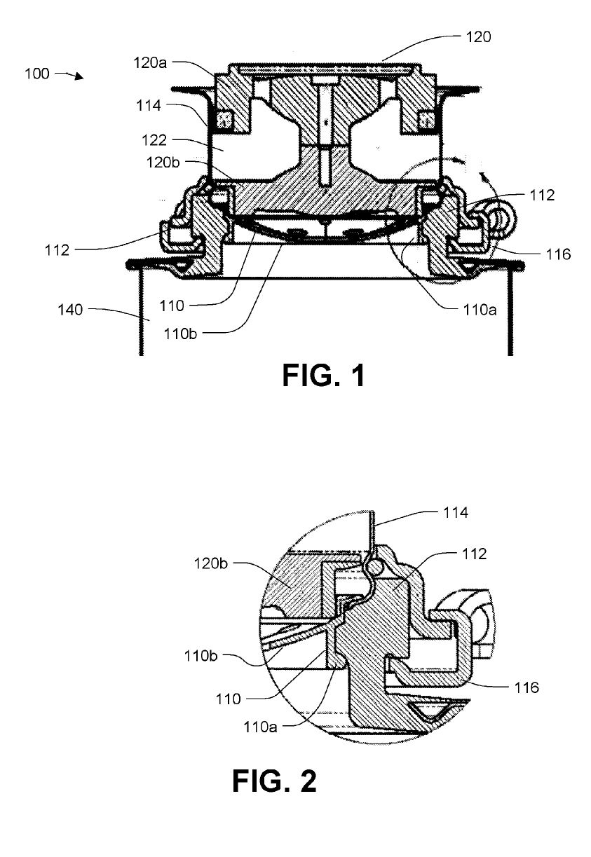

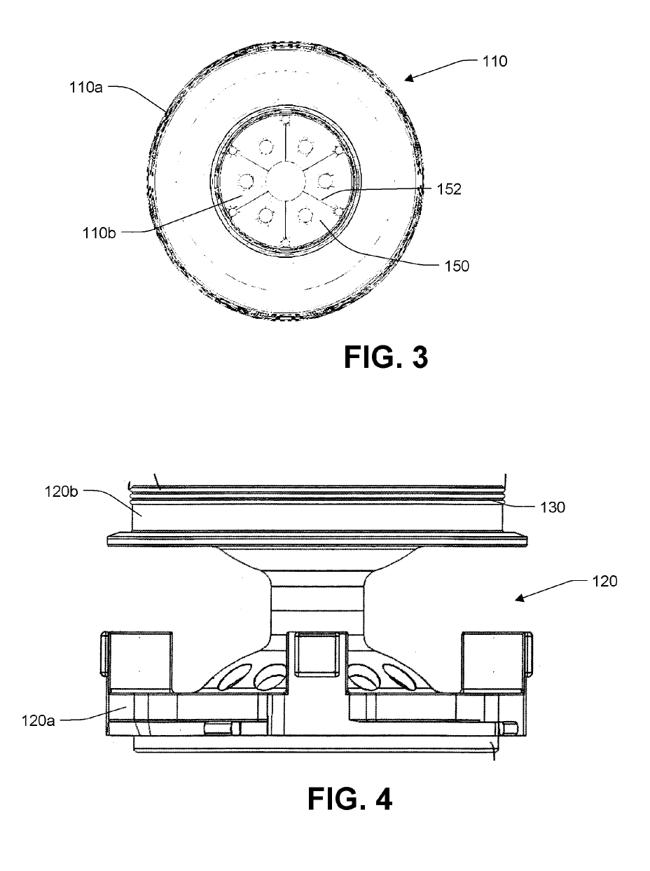

FIGS. 1 and 2 illustrate portions of a batch feed food waste disposer 100 employing a baffle 110. FIG. 3 is a top view of the baffle 110. The disposer 100 includes an anti-vibration mount 112 situated between a sink flange 114 and the disposer mounting hardware 116. A stopper 120 is positioned in a drain opening 122 formed by the sink flange 114. In a batch feed disposer, the stopper 120 functions to activate the disposer when it is situated in the drain opening 122. The drain opening 122 functions as an inlet to the disposer 100 for receiving food waste, which is conveyed from the inlet to a grinding section 140. The grinding section 140 includes any suitable grinding mechanism.

FIG. 3 shows one exemplary embodiment of the baffle 110. The outer lip 110a of the baffle 110 is fabricated from a relatively hard material so that the baffle 110 securely stays in place. Inner portions 110b of the baffle 110 define a plurality of flexible flaps 150. The flaps 150 are separated from adjacent flaps by slots 152. Other suitable configurations for the inner portion 110b are shown, for example, in commonly assigned U.S. patent application Ser. No. 10/066,893, now U.S. Pat. No. 6,719,228, which is incorporated by reference. The inner portions 110b are made of a softer, more flexible material that the outer lip 110a to allow food waste to pass through the flaps 150 as desired. For instance, the outer lip 110a may be fabricated of plastic while the inner portion 110b is made of rubber. Or, the both portions may be fabricated from rubber, with the outer lip 110a being formed of a harder durometer rubber. Fabricating the baffle 110 in this manner allows removal of the baffle 110 without tools or disassembling the disposer for easy cleaning by a user.

FIG. 4 shows an exemplary embodiment of the stopper 120. With the stopper 120 in the drain opening 122 (switch position), it needs to slide or rotate on the upper portion of the baffle lip 110a to activate the unit. In exemplary embodiments, the baffle 110 has at least a 0.060 inch hard plastic lip at top of the baffle 110 to keep the baffle 110 from pushing through the sink flange 114. The stopper includes a switch portion 120a and a plug portion 120b. With a batch feed disposer, food waste is placed into the inlet and the switch portion 120a of the stopper 120 is inserted into the drain opening 122. The stopper is then rotated to activate a switch, controlling operation of the disposer. Exemplary stoppers for batch feed disposers are disclosed in commonly assigned U.S. patent application Ser. Nos. 10/389,142 and 10/389,160, both of which are incorporated by reference.

As shown in FIGS. 1 and 2, the stopper 120 is situated with the plug portion 120b received by the top rubber inside diameter of the baffle 110. The plug portion 120b includes sealing rings 130 that are received by the baffle 110. When the stopper 120 is positioned with the switch portion 120a received in the drain opening 122, the stopper 120 rides on the upper lip of the outer portion 110a.

The baffle 110 controls the passage of water through the stopper 120 and the sink flange 114, forming a labyrinth or maze-like path through which the water and sound generated by the disposer must travel. The baffle 110 holds a film of water, providing another level of sound barrier. Thus, the baffle helps to reduce the noise generated by the disposer. The combination of the baffle 110 and stopper 120 results in a very quiet disposer.

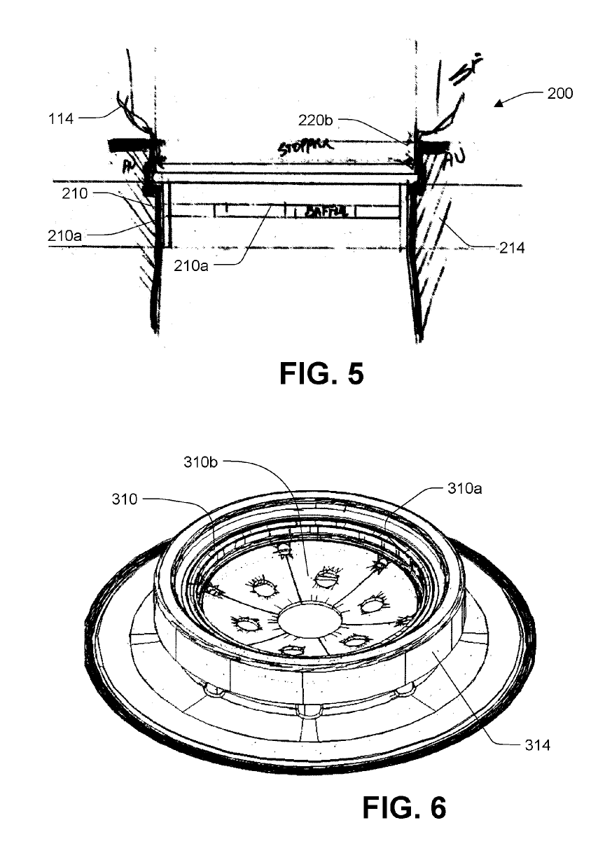

FIG. 5 shows portions of an alternative disposer system 200, having an under-cut mount baffle 210. The hard outer portion 210a is molded into the bottom half outside diameter of the baffle 210. Stopper plug end 220b is sized to plug into the anti-vibration mount 214 inside diameter at the lower sink-flange opening.

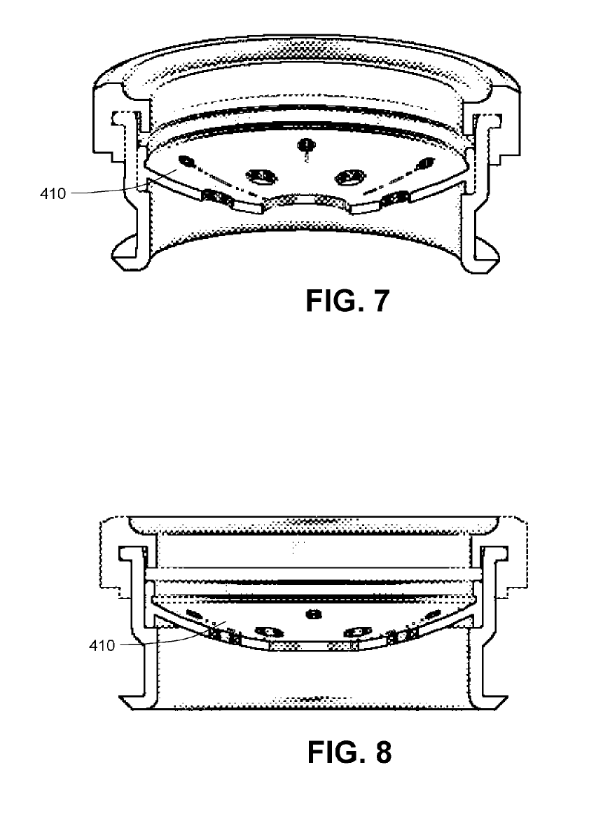

FIG. 6 shows another alternative baffle 310. The top of the outer portion 310a is molded rubber and is trapped between the sink-flange and the anti-vibration mount 314 when they are assembled. The inside diameter of the baffle 310 is sized to the outside diameter of the stopper plug. The outside diameter of the baffle 310 is sized to the inside diameter of the anti-vibration mount 314. FIGS. 7 and 8 illustrate yet another alternative baffle configuration 410.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A batch feed food waste disposer, comprising:
an inlet for receiving food waste;
a grinding section for grinding the food waste;
a stopper receivable by the inlet, the stopper including first and second ends, the first end defining a plug portion, the second end defining a switch portion; and
a baffle situated between the inlet and the grinding section.

2. The food waste disposer of claim 1, wherein the second end of the stopper activates the disposer when received in the inlet.

3. The food waste disposer of claim 1, wherein the baffle includes an outer lip about the periphery of the baffle, and an inner portion defining an opening therethrough, the outer lip made of material stiffer than the inner portion.

4. The food waste disposer of claim 3, wherein the outer lip comprises the bottom half outside diameter of the baffle.

5. The food waste disposer of claim 1, wherein the baffle defines an inside diameter and the stopper plug end defines an outside diameter, wherein the inside diameter of the baffle is approximately equal to the outside diameter of the plug end of the stopper.

6. The food waste disposer of claim 3, wherein the stopper contacts the outer lip when received in the inlet.

7. The food waste disposer of claim 1, wherein the plug portion includes sealing rings that are receivable by the baffle.

8. The food waste disposer of claim 1, further comprising an anti-vibration mount, wherein the baffle includes an outer lip that mates with the anti-vibration mount.

9. The food waste disposer of claim 8, wherein the baffle is removable without tools.

10. The food waste disposer of claim 1, wherein the baffle holds a film of water that functions as a sound barrier.

11. A food waste disposer, comprising:
an inlet for receiving food waste;
a grinding section for grinding the food waste;
first means receivable by the inlet for alternatively plugging the inlet or activating the disposer; and
second means for preventing unwanted items from entering the grinding section.

12. The food waste disposer of claim 10, wherein the second means is situated between the inlet and the grinding section.

13. A method of operating a food waste disposer having an inlet for receiving food waste and a grinding section for grinding the food waste, the method comprising:
placing waste to be ground into the inlet;
inserting a switch end of a stopper into the inlet such that the stopper contacts a baffle; and
rotating the stopper to activate the disposer.

14. The method of claim 12, wherein the switch end contacts and rotates on an outer lip of the baffle.

15. The method of claim 12, further comprising removing the switch end from the inlet and inserting a plug end of the stopper into the inlet such that the plug end contacts the baffle.
